(19) United States
(12) Patent Application Publication
(10) Pub. No.: US 2007/0024016 A1
(43) Pub. Date: Feb. 1, 2007

(54) Parallel torsion suspension assembly

(75) Inventors: Steven W. Claussen, Benson, MN (US); Brett A. Duncan, Hancock, MN (US)

Correspondence Address: MUETING, RAASCH & GEBHARDT, P.A., P.O. BOX 581415, MINNEAPOLIS, MN, 55458, US

(73) Assignee: Redball, LLC, Benson, MN (US)

(21) Appl. No.: 11/194,274

(22) Filed: Aug. 1, 2005

(51) Int. Cl. B60G 11/18

(52) U.S. Cl. 280/124.166

(57) ABSTRACT

A suspension assembly for a carriage includes a first torsion assembly connected to a second torsion assembly in parallel such that force delivered to the first and second torsion assemblies through the wheels is distributed between the first and second torsion assemblies.

### BACKGROUND

The present invention relates to a suspension assembly for a carriage (e.g., vehicles or towed apparatus bearing heavy loads, such as agricultural and construction carriages).

A variety of suspension systems are available to minimize the effects of surface irregularities on moving carriages. Depending on the type of carriage and its expected use, these suspension systems may include oil or air-type shock absorbers, coil springs, leaf springs, or elastic torsion rods.

U.S. Pat. No. 3,436,069, entitled “Bearing Assembly for Elastic Joints” and issued to Henschen on Apr. 1, 1969, describes elastic torsion rods having concentrically arranged inner and outer tubular members with a polygonal cross-section configuration. The inner member of the elastic torsion rod is spaced apart from the outer member by a plurality of elongated cushioning rollers that are disposed between an external surface of the inner member and a pair of intersecting internal surfaces of the outer tubular member. The cushioning rollers yieldingly resist the relative rotation of the inner and outer members about a common axis.

In operation, torque applied to the elastic torsion rod causes the inner member to rotate with respect to the outer member through an angle varying with the amount of torque applied. With the outer member rigidly held against rotation, rotation of the inner member is resisted by the elongated cushioning rollers, providing a suspension effect that dampens the effects of mechanical shocks delivered to the torsion rod. However, if excessive force is applied to the torsion rod, the elongated cushioning rollers may tear or otherwise be damaged, resulting in a partial or complete loss of function for the elastic torsion rod.

Various improvements of suspension systems using elastic torsion rods can be found in the art. For example, a multiple stage torsion axle is described in U.S. Pat. No. 5,277,450. In a multiple stage torsion axle, several inner members are mounted within the outer tubular member, with inner members at the center of the axle being secured to the surrounding outer tubular member. This allows various degrees of rotation over the length of the torsion axle. Multiple stage torsion axles may provide a smoother ride under various loading conditions, but limit wheel travel to within a relatively small range.

Another suspension system using multiple elastic torsion rods, intended to address the problem of limited wheel travel, is described in U.S. Pat. No. 6,877,728, entitled “Suspension Assembly Having Multiple Torsion Members Which Cooperatively Provide Suspension To A Wheel” and issued to Gehret on Apr. 12, 2005. U.S. Pat. No. 6,877,728 describes a suspension system in which one torsion member is connected to the frame of a carriage. This torsion member is then coupled to a second torsion member that is connected to wheel arms. When a load is applied to this suspension system, force from the load is first absorbed by one torsion member, while the other torsion member serves primarily in a reserve capacity. However, as the load is increased, force will increasingly be absorbed by the second torsion member as well. While this arrangement again provides a smoother ride, it does not necessarily protect the torsion members from damage due to excessive force caused by significant terrain irregularities, and does not necessarily provide a steady suspension response for heavy loads.

There are a number of types of carriages (e.g. vehicles or apparatus towed by vehicles) that commonly carry heavy loads. For example, heavy loads are often carried by carriages used in construction and agriculture. For example, a field sprayer for agricultural use with a 1600 gallon tank may weigh over 15,000 pounds when fully loaded, while a standard dump truck can often carry loads of 25,000 pounds or more. When a heavy load is carried, torsion rod systems using multiple components that are engaged by the load in a serial fashion such as described in U.S. Pat. No. 6,877,728, do not provide effective support.

Therefore, there is a need to provide a more effective suspension system, particularly one that is more suited for suspension of heavy loads (e.g., a stiffer suspension response).

### SUMMARY OF THE INVENTION

The present invention satisfies the need for a more effective suspension system described above. In one aspect, the present invention provides a suspension assembly for a carriage that includes a first elongated torsion assembly connectable within a frame of the carriage along a first axis, wherein the first elongated torsion assembly includes a first elongate member and a second elongate member, and further wherein the first elongate member is rotatable relative to the second elongate member about the first axis. The suspension assembly also includes a second elongated torsion assembly connectable within the frame along a second axis, wherein the first axis is parallel to the second axis, wherein the second elongated torsion assembly includes a first elongate member and a second elongate member, and further wherein the first elongate member is rotatable relative to the second elongate member about the second axis. Furthermore, the suspension assembly includes a wheel support apparatus that is pivotally attachable to the frame and a connector apparatus operatively connectable to the elongated torsion assemblies and the wheel support apparatus such that movement of the connector apparatus upon movement of the wheel support apparatus results in rotation of the first elongate members relative to the second elongate members of both the first and second elongated torsion assemblies.

In one embodiment of this aspect of the invention, the suspension assembly may include elongated torsion assemblies that further include a plurality of cushioning rollers disposed between the first and second elongate member thereof.

In an additional embodiment, each of the first elongate members may include an inner member connectable in a fixed position within the frame and each of the second elongate members include an outer member connectable to the connector apparatus so as to allow rotation of the outer members of the elongated torsion assemblies about the inner members.

In a further embodiment, the suspension assembly may further include one or more additional elongated torsion assemblies connectable within the frame along one or more additional axis parallel to the first axis and second axis, wherein the additional torsion assemblies each include at least first and second elongate members, and further are operatively connectable such that movement of the connector apparatus upon movement of the wheel support apparatus results in rotation of each of the first elongate members relative to the second elongate members of all the elongated torsion assemblies.

In an additional embodiment of this aspect of the invention, the suspension assembly may include a torsion assembly mount connectable to the frame, wherein the first and second elongated torsion assemblies are connected within the frame using the torsion assembly mount, and wherein the wheel support apparatus is pivotally attached to the torsion assembly mount. In a further embodiment, the movement of the connector apparatus that connects the elongated torsion assemblies may result in equal rotation of the first elongate members relative to the second elongate members of all of the elongated torsion assemblies.

In an additional embodiment of this aspect of the invention, the suspension assembly may include a connector apparatus that includes a first offset arm and a second offset arm that are pivotally connected to a force transfer member, wherein a first end of the first offset arm is connected to the first elongate member of first elongated torsion assembly and a first end of the second offset arm is connected to the first elongate member of the second elongated torsion assembly. In a further aspect of this embodiment of the invention, the first offset arm connects to the force transfer member at a distance from the first axis equal to the distance that the second offset arm connects to the force transfer member from the second axis, and wherein movement of the connector apparatus that connects the elongated torsion assemblies results in equal rotation of the first elongate members relative to the second elongate members of the first and second elongated torsion assemblies.

In a further embodiment of this aspect of the invention, the suspension assembly may include a wheel support apparatus that is attachable to the connector apparatus by an adjustable pin. In an additional embodiment, the wheel support apparatus may include an elongate axle with a wheel hub attached at each end. In yet another embodiment, the wheel support apparatus may include a stop device that limits the pivotal movement of the wheel support apparatus relative to the frame. Finally, in another embodiment, a force transmitted from the wheel support apparatus may be absorbed evenly by all of the elongated torsion assemblies.

In another aspect, the present invention provides a carriage having a torsion suspension assembly. The carriage includes a frame, a first elongated torsion assembly connected within the frame along a first axis, wherein the first elongated torsion assembly includes a first elongate member and a second elongate member, and further wherein the first elongate member is rotatable relative to the second elongate member about the first axis. The carriage also includes a second elongated torsion assembly connected within the frame along a second axis, wherein the first axis is parallel to the second axis, wherein the second elongated torsion assembly includes a first elongate member and a second elongate member, and further wherein the first elongate member is rotatable relative to the second elongate member about the second axis. The carriage also includes a wheel support apparatus that is pivotally attached to the frame, and a connector apparatus operatively connected to the elongated torsion assemblies and the wheel support apparatus such that movement of the connector apparatus upon movement of the wheel support apparatus results in rotation of the first elongate members relative to the second elongate members of both the first and second elongated torsion assemblies.

In one embodiment of this aspect of the carriage, each of the first elongate members may include an inner member connectable in a fixed position within the frame and each of the second elongate members include an outer member connectable to the connector apparatus so as to allow rotation of the outer members of the elongated torsion assemblies about the inner members.

In another embodiment, the suspension assembly may further include one or more additional elongated torsion assemblies connectable within the frame along one or more additional axis parallel to the first axis and second axis, wherein the additional torsion assemblies each include at least first and second elongate members, and further are operatively connectable such that movement of the connector apparatus upon pivotal movement of the wheel support apparatus results in rotation of each of the first elongate members relative to the second elongate members of all the elongated torsion assemblies.

In another embodiment, the carriage may include a torsion assembly mount connectable to the frame, wherein the first and second elongated torsion assemblies are connected within the frame using the torsion assembly mount, and wherein the wheel support apparatus is pivotally attached to the torsion assembly mount. In yet another embodiment, the connector apparatus that connects the elongated torsion assemblies may result in equal rotation of the first elongate members relative to the second elongate members of all of the elongated torsion assemblies. In a further embodiment, the wheel support apparatus further may include a stop device that limits the pivotal movement of the wheel support apparatus relative to the frame. Finally, in a further embodiment of the carriage, a force transmitted from the wheel support apparatus is absorbed evenly by all of the elongated torsion assemblies.

In another aspect, the present invention provides a method of absorbing a mechanical shock delivered to a carriage that includes providing a first elongated torsion assembly connected within a frame of the carriage along a first axis and a second elongated torsion assembly connected within the frame along a second axis, wherein the first axis is parallel to the second axis. The method further includes providing a wheel support apparatus that is pivotally attached to the frame of the carriage and connected to each of the elongated torsion assemblies such that movement of the wheel support apparatus that results in absorption of at least a portion of the mechanical shock by the first elongated torsion assembly also results in absorption of at least a portion of the mechanical shock by the second elongated torsion assembly.

In an additional embodiment of this aspect of the invention, absorption of the mechanical shock may be distributed evenly between the first elongated torsion assembly and the second elongated torsion assembly.

### BRIEF DESCRIPTION OF THE FIGURES

FIG. 1 is a side view of an agricultural trailer carriage including a field sprayer with one wheel exploded therefrom. An exemplary embodiment of the suspension assembly of the present invention is positioned within a frame of the carriage.

FIG. 2 is a perspective view of the suspension assembly shown in FIG. 1.

FIG. 3 is a perspective cut-away view of the suspension assembly shown in FIG. 2.

FIG. 4 is a bottom plan view of an embodiment of the suspension assembly of FIG. 2.

FIG. 5 is a side view of the suspension assembly of FIG. 2.

FIG. 6 is a side view of the suspension assembly of FIG. 2 traveling over a significant terrain irregularity.

### DETAILED DESCRIPTION OF EMBODIMENTS OF THE INVENTION

The following discussion is presented to enable a person skilled in the art to make and use the invention. Various modifications will be readily apparent to those skilled in the art, and the general principles disclosed herein may be applied to other embodiments and applications without departing from the scope of the present invention as defined by the appended claims. Thus, the present invention is not intended to be limited to the embodiments shown, but is to be accorded the widest scope consistent with the principles and features disclosed herein.

The following detailed description is to be read with reference to the figures, in which like elements in different figures have like reference numerals. The figures, which are not necessarily to scale, depict selected embodiments and are not intended to limit the scope of the invention. Skilled artisans will recognize the embodiments provided herein have many useful alternatives that fall within the scope of the invention.

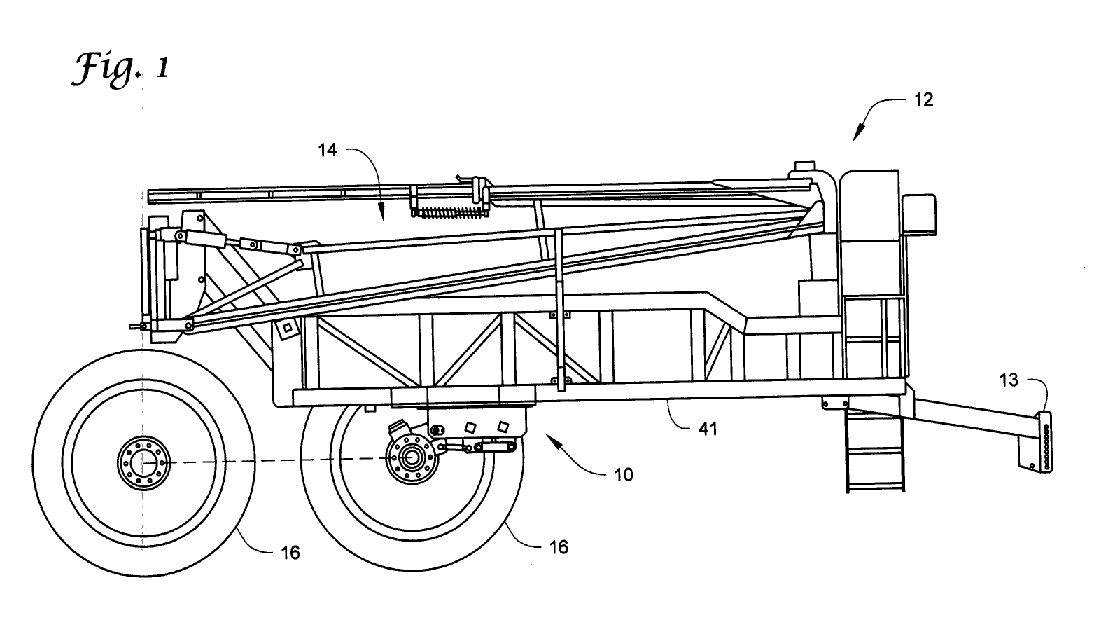

FIGS. 1 through 6 illustrate a suspension assembly 10 of an exemplary embodiment of the invention. Specifically, FIG. 1 shows an embodiment of the invention in which the carriage 12 is illustrated as a trailer bearing a field sprayer 14. The trailer is one example of a carriage 12 that can use the suspension assembly 10 of the present invention.

A carriage, as defined herein, is a wheeled vehicle or a wheeled support or frame for carrying an object (e.g., a heavy object such as a sprayer). Examples of carriages include a trailer, a wagon, an automobile, a truck, a recreation vehicle, and a tractor. An example of heavy objects that may be carried on the frame of a carriage includes agricultural equipment such as a field sprayer 14. Carrying a heavy object may make the loaded carriage 12 substantially heavier than a typical carriage. For example, in one aspect, a heavy object is an object weighing 5,000 pounds or more. In further aspects, the heavy object may be an object weighing 10,000 pounds or more, or in a further aspect, an object weighing 15,000 pounds or more. Embodiments of the suspension assembly 10 of the invention are well suited to carriages 12 that routinely carry heavy objects.

In the embodiment shown in FIG. 1, the carriage 12 is illustrated as an agricultural trailer whose wheels 16 are not driven by drive axles or a drive transmission. One of the wheels 16 is exploded from the carriage 12 to reveal the suspension assembly 10. The embodiment shown also includes a hitch 13 that is used to reversibly attach the carriage 12 to another carriage or vehicle. Furthermore, the suspension assembly 10 functions in this embodiment as a carriage axle in addition to functioning as a suspension system by being adapted to bear wheels and enable their rotation beneath the carriage. While FIG. 1 illustrates an embodiment in which the wheels are not powered, in other embodiments the suspension assembly 10 of the present invention can provide suspension for wheels that are driven, for example, by a transmission. The suspension assembly 10 can be readily adapted by one skilled in the art to include a transmission that drives the wheels.

FIG. 1 further shows that the carriage 12 can be provided with a suspension assembly 10, in one aspect of the invention, by attaching the suspension assembly 10 to a frame 41 associated with the equipment being supported. The figure also shows that one or more wheels 16 may be attached to a wheel support apparatus 24. The suspension assembly 10 absorbs mechanical shocks or other undesired vibrations imparted to the carriage 12 and/or the suspension assembly 10 as the carriage 12 travels over terrain irregularities.

A mechanical shock, as defined herein, is an impulse of locomotive force. The manner in which mechanical shocks are absorbed will be described in more detail herein. The size of the mechanical shock is based on factors such as, for example, the weight of the carriage and its load, the irregularity of the terrain, and the speed of the vehicle. By connecting the suspension assembly 10 to the frame 41, the suspension assembly 10 is able to support the weight of the carriage 12 and is positioned to absorb mechanical shocks delivered to the carriage and/or the suspension assembly 10.

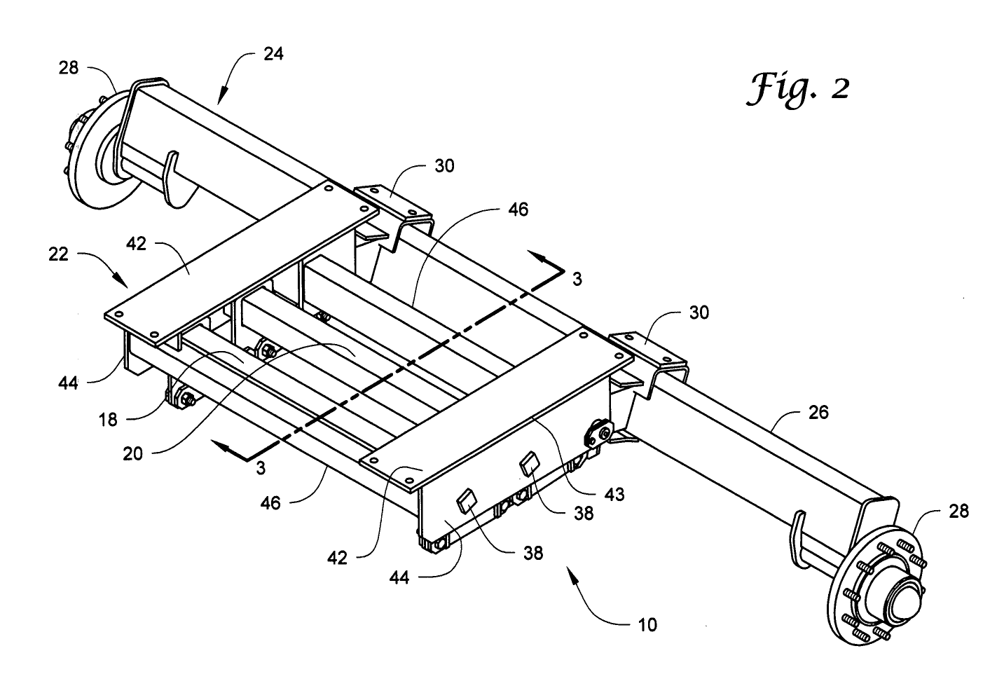

A perspective view of an embodiment of the suspension assembly 10 is provided by FIG. 2. The suspension assembly 10 includes a first elongated torsion assembly 18 and a second elongated torsion assembly 20 that are operatively connected at each end to a torsion assembly mount 22. The term “elongated” or “elongate,” as used herein, refers to a structure with two ends that has a length that is greater than its diameter. In one embodiment, the elongate structure may have a rectangular cross-section. Alternately, other embodiments may have a cross-section with different dimensions, such as a triangular, circular, hexagonal, or oval cross-section.

The elongated torsion assemblies 18 and 20 are operably connected to a wheel support apparatus 24. The wheel support apparatus 24 is pivotably connected to the torsion assembly mount 22, and is further operatively connected to the elongated torsion assemblies 18 and 20 in a manner that enables the elongated torsion assemblies 18 and 20 to absorb mechanical shocks received by the wheel support apparatus 24, as will be described in more detail herein.

While the figures illustrate an embodiment of the invention using only two elongated torsion assemblies (18 and 20), embodiments of the invention also include suspension assemblies 10 that include more than two elongated torsion assemblies. These additional elongated torsion assemblies can be connected to the frame 41 or the torsion assembly mount 22 as described herein, as well as being connected in parallel with the other elongated torsion assemblies through a connector apparatus. The additional elongated torsion assemblies should also be mounted such that they are parallel to the existing torsion assemblies. In a further aspect, the additional torsion assemblies are connected, as described herein, such that force delivered through the wheel support apparatus 24 is divided evenly between all of the torsion assemblies present in the suspension assembly 10.

Evenly divided force, as referred to herein, is force that is distributed in about the same amount to each of the elongated torsion assemblies. For example, if a third elongated torsion assembly was connected to the first and second elongated torsion assemblies in an embodiment providing evenly divided force, each of the torsion assemblies would absorb about one third of the force delivered through the wheel support apparatus 24. In a further embodiment, evenly distributed force varies by 10% or less when comparing the force received by one elongated torsion assembly to another in the same suspension assembly.

The embodiment of the wheel support apparatus 24 shown in FIG. 2 includes an elongate axle 26 that has a wheel hub 28 attached at each end. The wheel support apparatus 24 in this embodiment also includes a stop device 30 that protects the frame and wheel support apparatus 24 and may operate together with the torsion assembly mount 22 or the frame of the carriage to reduce or prevent overtorsioning of the elongated torsion assemblies.

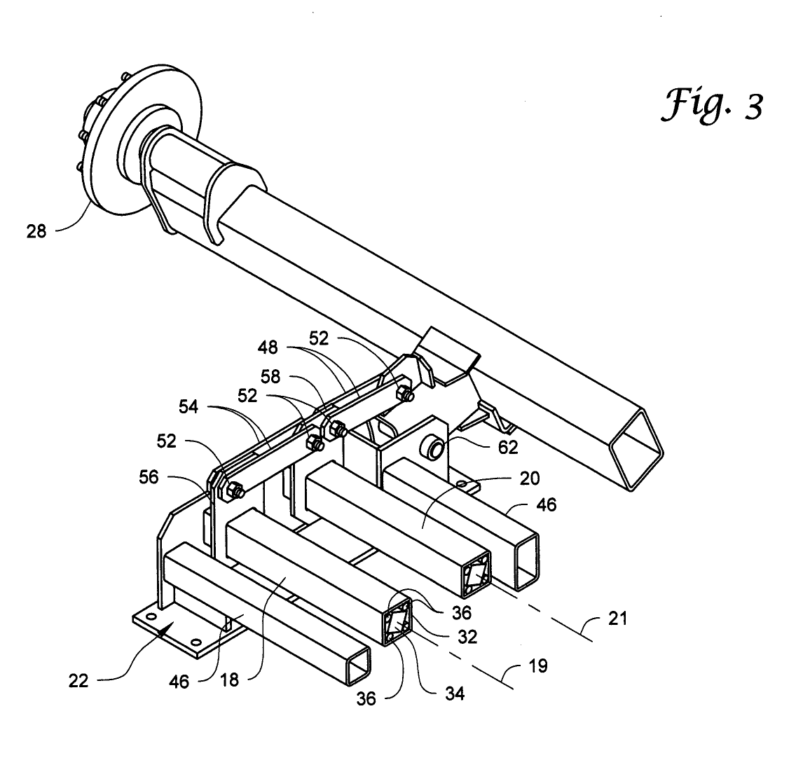

FIG. 3 provides a perspective cut-away view of the suspension assembly 10 shown in FIG. 2. This figure illustrates the components of an embodiment of the elongated torsion assemblies in order to facilitate explaining their operation. Note that although the first elongated torsion assembly 18 and the second elongated torsion assembly 20 are essentially identical, other embodiments of the invention may use elongated torsion assemblies that are different in size and configuration.

For purposes of illustrating the manner in which the elongated torsion assemblies absorb mechanical force transmitted to them, the first elongated torsion assembly 18 will be used as an example. However, the second elongated torsion assembly 20, as well as any additional elongated torsion assemblies included in the suspension assembly 10, may operate in the same fashion. Examples of a torsion assemblies suitable for use in the present invention are described by Henschen in U.S. Pat. No. 3,436,069, which is incorporated by reference herein. Further, for example, such torsion assemblies may be Henschen DURA-FLEX™ rubber torsion axles generally available from QDS/Henschen Inc., Jackson Center, Ohio.

In one embodiment, the elongated torsion assembly 18 includes a first and second elongate member; one of such members rotatable relative to the other elongate member about an axis. Rotation of the elongate members relative to each other is used to absorb mechanical force that is delivered to the elongated torsion assembly.

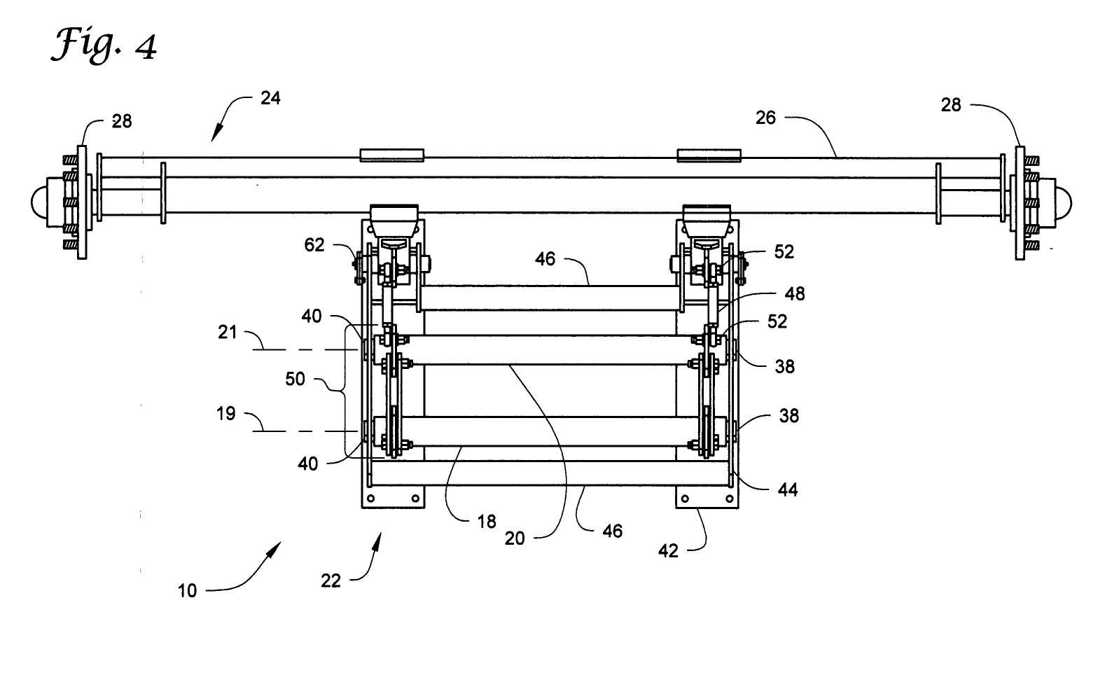

In a further embodiment of the invention, a second elongate member 32 is an outer member that houses a first elongate member 34, which may then be referred to as an inner member. A plurality of cushioning rollers 36 may be positioned between the second elongate member 32 and the first elongate member 34. In one aspect of the invention, the first elongate member 34 is a substantially square shaped solid steel rod, tube or shaft having ends 38 and 40 (shown in FIG. 4). The ends 38 and 40 can have any suitable size or shape for operatively being connected to the frame 41 or the torsion assembly mount 22. In further embodiments of the invention, the second elongate member 32 is also a substantially square shaped rigid tube constructed of a suitable steel or metal, and extends nearly to the ends 38 and 40 of the first elongate member 34, as shown in FIG. 4.

In one embodiment, the cushioning rollers 36 are each a flexible elastomeric material (e.g., rubber) that is rod shaped. It should be appreciated that the cushioning rollers 36 can include any suitable cushioning member, biasing member, elastomeric member or any other member constructed of any suitable elastomeric material. Although in one embodiment the cushioning rollers 36 have a substantially circular cross-sectional shape, the cushioning rollers 36 can be adapted to have any suitable geometric shape.

In one embodiment, the ends 38 and 40 of the first elongate member 34 are connected to a torsion assembly mount 22, as shown in FIG. 2, preferably by welding. In another embodiment, the ends 38 and 40 are connected directly to the frame 41 of the carriage 12. In this configuration, the second elongate member 32 can pivotally rotate around the first elongate member 34. In an alternate embodiment, not shown in the figures, the second elongate member 32 may be fixed in place (e.g., to the frame 41 or the torsion assembly mount 22) while the first elongate member 34 is left free to pivotally rotate within the second elongate member 32.

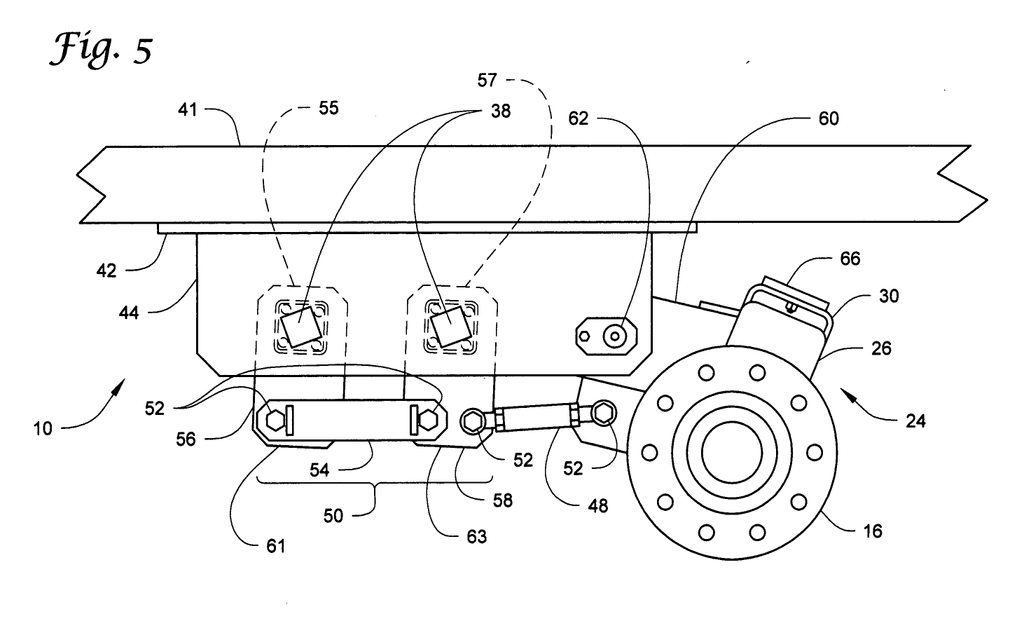

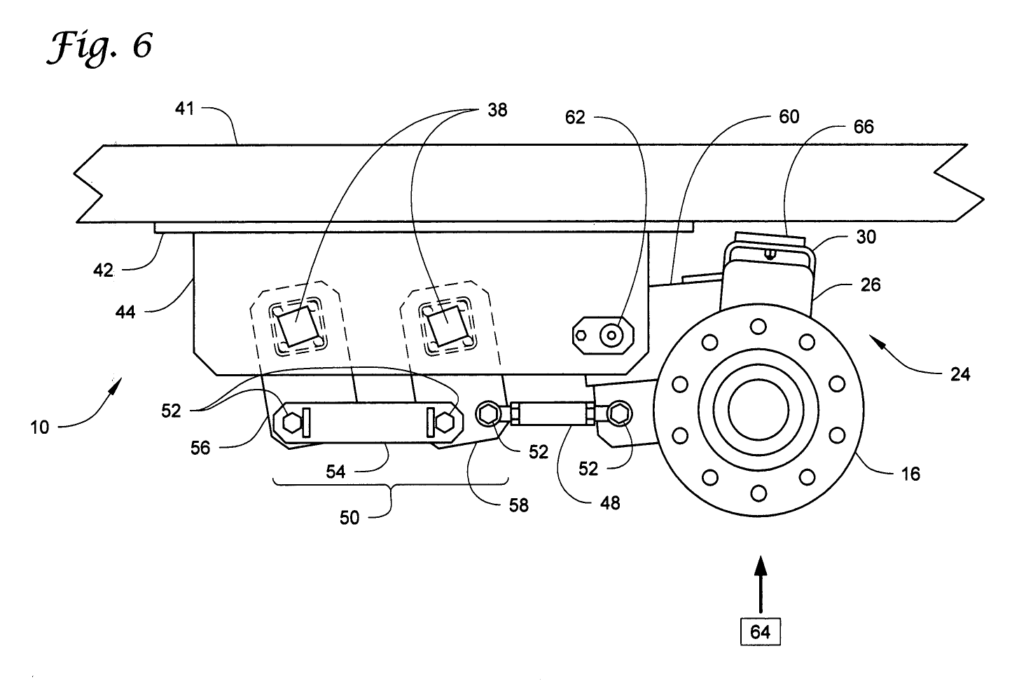

Operation of the suspension assembly 10 of the invention is readily understood through reference to FIG. 3 through FIG. 6. FIG. 3 and FIG. 4 provide bottom views of an embodiment of the suspension assembly 10 that illustrate the placement and linkage of the elongated torsion assemblies 18 and 20 within the suspension assembly 10. FIG. 5 provides a side view of an embodiment of the suspension assembly 10, showing the suspension assembly 10 in a relatively relaxed position as would typically be seen during travel over a relatively smooth surface, while FIG. 6 provides a side view of the same embodiment of the suspension assembly 10 immediately after delivery of a substantial mechanical shock that has driven the wheel 16 upwards.

In FIG. 4, the elongated torsion assemblies 18 and 20 can be seen transversely connected to the torsion assembly mount 22. While in one embodiment the elongated torsion assemblies 18 and 20 are connected to a torsion assembly mount 22, in alternate embodiments of the invention the elongated torsion assemblies 18 and 20 may be connected directly to the frame 41 of the carriage 12. The frame 41 of the carriage 12, as defined herein, is a support member or set of support members that provide a sturdy structure upon which the other components of the carriage rest. In other words, the torsion assembly mount 22 may form a part of the frame 41 or may be separate from the frame 41 and attachable to the frame 41. As such, when the torsion assemblies 18 and 20 are connected within the frame of the carriage 12, it is generally referring to either direct mounting of the assemblies in the frame 41 using the torsion assembly mount 22 to mount the elongated torsion assemblies 18 and 20 within the frame 41, or any use of any other structure to hold the elongated torsion assemblies 18 and 20 in a desired position in the carriage 12 suitable to operate effectively.

In the embodiment shown, the first elongate member 34 of each of the elongated torsion assemblies 18 and 20 is secured to the frame 41 or the torsion assembly mount 22 at its two ends 38 and 40 so that it is fixed in position (i.e., does not rotate). The second elongate member 32, on the other hand, is not fixed to the frame 41 or the torsion assembly mount 22, but rather is free to pivotally rotate, being restrained primarily by the elastic resistance of the cushioning rollers 36. Pivotable movement, as defined herein, refers to partial rotation around an axis, but not a full (i.e. 360 degree) rotation. Pivotable rotational movement around an axis in the invention is preferably rotation through 90 degrees or less. A portion of the first elongated torsion assembly 18 is thus pivotable around a first axis 19, while a portion of the second elongated torsion assembly 20 is pivotable around a second axis 21.

The elongated torsion assemblies 18 and 20 are transversely connected so that the first axis 19 and second axis 21 are parallel to each other. Parallel placement of the elongated torsion assemblies is preferred as parallel placement facilitates even distribution of mechanical force to the elongated torsion assemblies. However, in additional embodiments of the invention, non-parallel placement of the elongated torsion assemblies may be used, particularly since the wheel axles are not positioned along the axis of the elongated torsion assemblies, with a suitably sized connector apparatus 50 compensating for the non-parallel placement, if desired.

In the embodiment shown in the figures, the torsion assembly mount 22 includes two long rectangular horizontal platforms 42 that each include a perpendicular rectangular sidewall 44 extending therefrom near the outside edge 43. The rectangular sidewalls 44 provide support for the elongated torsion assemblies and a connection point for a pin 48 that is connected to the wheel support apparatus 24. The torsion assembly mount 22 functions primarily as a positioning device for the working components of the suspension assembly 10, which include the elongated torsion assemblies 18 and 20 and the wheel support apparatus 24 (see FIG. 5).

Accordingly, the shape of the torsion assembly mount 22 can vary considerably so long as it remains capable of positioning the elongated torsion assemblies and connected to the wheel support apparatus 24 such that these components are relatively parallel to one another and pivotable. The torsion assembly mount 22 may also include reinforcing bars 46 that provide structural strength for the torsion assembly mount 22. In one embodiment, the torsion assembly mount 22 is connected to the frame 41. The torsion assembly mount 22 may be connected using any suitable means; for example, it may be connected using a plurality of bolts that extend through the holes in the horizontal platforms 42.

During operation of the suspension assembly 10 of the invention, the wheel support apparatus 24 should be able to transmit mechanical force to the elongated torsion assemblies 18 and 20, which absorb the mechanical force as described herein. Mechanical force is transmitted to the elongated torsion assemblies 18 and 20 through the pin 48, which connects the wheel support apparatus 24 to a connector apparatus 50. The pin 48 is pivotably connected at each end by a pivotable connector 52 (e.g., a nut and bolt). One pivotable connector 52 connects the pin 48 to the wheel support apparatus 24, while the other pivotable connector 52 connects the pin 48 to the connector apparatus 50. Optionally, embodiments of the invention may use an adjustable pin 48. For example, FIG. 3 shows a standard, nonadjustable pin 48, while FIG. 4 shows an adjustable pin 48. An adjustable pin 48 has a variable length that may be set by the operator. By adjusting the length of the pin 48, different axle loading of one side of the carriage may be affected to adjust the axle to sit more level to the ground

Force transmitted by the pin 48 as result of the wheel support apparatus 24 moving relative to the frame 41 (e.g., pivoting at the pivot point 62) is received by the connector apparatus 50. The connector apparatus 50 joins the first elongated torsion assembly 18 to the second elongate torsion assembly 20 so that force received from the wheel support apparatus 24 results in rotation of the first elongate members relative to the second elongate members of both the first and second elongated torsion assemblies. Rotation of components of both of the elongated torsion assemblies 18 and 20 results in the mechanical force being absorbed by both of the elongated torsion assemblies.

In one embodiment, the force transmitted from the wheel support apparatus 24 is absorbed evenly by both the first elongated torsion assembly 18 and the second elongated torsion assembly 20. In embodiments of the invention, the connector apparatus 50 is offset from the elongated torsion assemblies so that force delivered to the connector apparatus 50 will result in pivotal rotation of components of the elongated torsion assemblies 18 and 20. Accordingly, in embodiments of the invention, the connector apparatus 50 should be positioned at a first distance away from the first axis within the first elongated torsion member 18, and a second distance away from the second axis within the second elongated torsion member 20. In one aspect of the invention, the first and second distances are equal distances. However, differing distances may be used in additional embodiments of the invention.

As shown more clearly in FIG. 5 and FIG. 6, in an additional embodiment of the invention, the connector apparatus 50 includes a force transfer member 54, a first offset arm 56, and a second offset arm 58. The first offset arm 56 is attached at a first end 55 to the second elongate member 32 of the first torsion assembly 18. A second offset arm 58 is attached at a first end 57 to the second elongate member 32 of the second torsion assembly 20. In some embodiments of the invention, the offset arms may be attached to outer members of the elongated torsion assemblies by providing a hole in the offset arm that is suitably shaped to contain the outer member while preventing its rotation within the hole. For example, in the embodiment provided in FIG. 2 and FIG. 3, it can be seen that the offset arms include square holes that provide a reliable connection to the square outer members of the elongated torsion members. The connection between the offset arms and the outer members should not allow pivotal rotation within this connection, as it is important that the each of the outer members move with their respective offset arm, resulting in the mechanical force being absorbed within the elongated torsion members. In alternate embodiments where the offset arms connect to the inner member, the outer member may be fixed in place while the offset arms connect with a portion of the first elongate member 34 (e.g., the inner member) that extends beyond the second elongate member 32 (e.g., the outer member).

The two offset arms 56 and 58 may be pivotally connected by a force transfer member 54 that pivotally connects a second end 61 of the first offset arm 56 to a second end 63 of the second offset arm 58 at pivotal connectors 52. The pivotal connectors may be, for example, a nut and bolt arrangement that penetrates a hole going through both the offset arm and the force transfer member.

The pin 48 may be connected to the second offset arm 58, as shown in the figures, or it may be connected directly to the force transfer member 54. When force is transmitted from the wheel support apparatus 24, the offset arms will pivotally rotate, resulting in pivotal rotation of a portion of the elongated torsion assemblies due to their linkage through the force transfer member 54. In one aspect of the invention, the torsion assemblies rotate by about an equal degree, resulting in an about an equal amount of the mechanical force being absorbed by each of the elongated torsion assemblies 18 and 20.

In this embodiment of the invention, where movement of the connector apparatus that connects the elongated torsion assemblies results in equal rotation of the first elongate members relative to the second elongate members of the first and second elongated torsion assemblies, the first offset arm connects to the force transfer member at a distance from the first axis equal to the distance that the second offset arm connects to the force transfer member from the second axis. The first and second distances are defined as the distance between the first and second axes, respectively, and the respective pivotal attachment points within the first and second offset arms. The length of the offset arms may be varied to increase or decrease the amount of torque applied to each of the elongated torsion assemblies 18 and 20.

The suspension assembly 10 of the invention also includes a wheel support apparatus 24. The wheel support apparatus 24 may serve several functions. For example, in some embodiments of the invention, it provides wheel hubs 28 that enable the wheels 16 to be attached to the suspension assembly 10. A variety of wheels may be used; for example, the wheels 16 may be durable rubber wheels on metal rims that can be bolted onto the wheel hubs 18. The wheel support apparatus 24 may contain one or more axles upon which the wheel hubs 28 rotate, allowing for rotation of the wheels 16 attached to the hubs during motion of the carriage 12. Examples of axles that may be used to mount the wheel hubs 28 include short wheel arms that extend from the ends of the elongate axle 26, or a long single axle that runs through the elongate axle 26. The elongate axle 26 itself should have a length sufficient to separate the wheels enough to provide a degree of stability for the carriage. For example, a typical agricultural carriage could use an elongate axle 26 that separates the wheels by about 10 feet.

The wheel support apparatus 24 may also include a pivot arm 60 that distances the wheel support apparatus 24 from the torsion assembly mount 22 and the frame 41, providing a length sufficient to allow the wheels 16 to travel upwards or downwards through an arc in response to terrain irregularities. The pivot arm 60 may be fixed to the elongate axle 26 and then pivotally attached to the torsion assembly mount 22 at the wheel pivot 62, which secures the wheel support apparatus 24 to the torsion assembly mount 22 while allowing pivotal movement. The wheel pivot 62 creates the axis around which the wheel support apparatus 24 partially rotates as the wheels move in response to terrain irregularities. Pivotal movement of the wheel support apparatus 24 is restrained in several ways. For example, pivotal movement of the wheel support apparatus 24 is restrained by the pin 48 that connects the wheel support apparatus 24 to the connector apparatus 50 and the attached elongated torsion assemblies.

As can be seen in FIG. 6, when the wheels 16 encounter a terrain irregularity 64, the wheels typically move upward, away from the obstacle. This moves the pin 48 to the rear of the carriage 12, causing movement of the connector apparatus 50. The connector apparatus 50 distributes the force of the movement between the elongated torsion assemblies 18 and 20, which absorb the force through rotation (as seen in FIG. 5 and FIG. 6).

As the terrain irregularity 64 is passed, the force absorbed by the elongated torsion assemblies 18 and 20 results in rotation of the assemblies, moving the pin 48 away from the rear of the carriage 12, and restoring the wheel support apparatus 24 to its original position. Note that should the terrain irregularity be a depression such as a pothole rather than an obstacle as shown in FIG. 6, force would be absorbed by the elongated torsion assemblies 18 and 20 through movement in the opposite direction.

In a further embodiment, pivotal movement of the wheel support apparatus 24 is restrained by the stop device 30. The wheel support apparatus 24 may include a stop device 30 that may be mounted, for example, on the top of the elongate axle 26. When the wheel support apparatus 24 moves upwards in response to encountering a terrain irregularity 64, as described, the movement is restrained by absorption of the mechanical force by the torsion assemblies 18 and 20. However, should a more severe obstacle be encountered, the wheel support apparatus 24 may receive sufficient mechanical force to cause it to travel an excessive distance. This can have at least two negative consequences. First, it may result in damage to the cushioning rollers 36 within the elongate torsion assemblies. Second, it may cause the wheel support apparatus 24 to strike the frame 41 or the torsion assembly mount 22 of the vehicle with excessive force, which can damage the wheel support apparatus 24, or the frame 41 or the torsion assembly mount 22, and result in a significant mechanical shock to occupants of the carriage.

Including a stop device 30 prevents excessive travel of the wheel support apparatus 24, and further can serve to absorb the impact caused by a severe obstacle. This is particularly true when the stop device 30 is provided with a cushioning layer 66 made of rubber or a similar elastomeric material that helps absorb and cushion the impact between the stop device 30 and the frame 41, as is employed in at least the exemplary embodiment of the invention.

While the present invention has heretofore defined a carriage 12 as a wheeled vehicle or a wheeled support or frame for carrying a heavy object, additional embodiments of the invention may include a wheel support apparatus 24 that uses support members other than wheels. For example, skis may be used with the suspension assembly 10, or alternately wheeled tracks may be provided. The primary changes needed to convert the wheel support apparatus 24 to a support apparatus that does not use wheels would involve adapting the wheel hubs 28 to support alternate support members such as skis or tracks. Otherwise, the suspension assembly 10 would function in the same manner as described herein.

It will also be appreciated by those skilled in the art that the suspension assembly 10 of the invention can operate using a single wheel 16 or other support member that is connected to the elongated torsion assemblies as described herein. However, the embodiments shown in the figures use a suspension assembly 10 that includes two wheels 16 and two connection systems (i.e., the connector apparatus 50 and the pin 48) between the wheels, the frame, and the elongated torsion assemblies, as two wheels and two connection systems provide more stable and durable support. It will be further understood by those skilled in the art that additional wheels and/or connections between the wheels may be included while remaining within the scope of the invention.

While various embodiments in accordance with the present invention have been shown and described, it is understood the invention is not limited thereto, and is susceptible to numerous changes and modifications as known to those skilled in the art. Therefore, this invention is not limited to the details shown and described herein, and includes all such changes and modifications as encompassed by the scope of the appended claim.

What is claimed is:

1. A suspension assembly for a carriage, comprising:
a first elongated torsion assembly connectable within a frame of the carriage along a first axis, wherein the first elongated torsion assembly comprises a first elongate member and a second elongate member, and further wherein the first elongate member is rotatable relative to the second elongate member about the first axis;
a second elongated torsion assembly connectable within the frame along a second axis, wherein the first axis is parallel to the second axis, wherein the second elongated torsion assembly comprises a first elongate member and a second elongate member, and further wherein the first elongate member is rotatable relative to the second elongate member about the second axis;
a wheel support apparatus that is pivotally attachable to the frame; and
a connector apparatus operatively connectable to the elongated torsion assemblies and the wheel support apparatus such that movement of the connector apparatus upon movement of the wheel support apparatus results in rotation of the first elongate members relative to the second elongate members of both the first and second elongated torsion assemblies.

2. The suspension assembly of claim 1, wherein each of the elongated torsion assemblies further comprise a plurality of cushioning rollers disposed between the first and second elongate member thereof.

3. The suspension assembly of claim 1, wherein each of the first elongate members comprise an inner member connectable in a fixed position within the frame and each of the second elongate members comprise an outer member connectable to the connector apparatus so as to allow rotation of the outer members of the elongated torsion assemblies about the inner members.

4. The suspension assembly of claim 1, wherein the suspension assembly further comprises one or more additional elongated torsion assemblies connectable within the frame along one or more additional axis parallel to the first axis and second axis, wherein the additional torsion assemblies each comprise at least first and second elongate members, and further are operatively connectable such that movement of the connector apparatus upon movement of the wheel support apparatus results in rotation of each of the first elongate members relative to the second elongate members of all the elongated torsion assemblies.

5. The suspension assembly of claim 1, further comprising a torsion assembly mount connectable to the frame, wherein the first and second elongated torsion assemblies are connected within the frame using the torsion assembly mount, and wherein the wheel support apparatus is pivotally attached to the torsion assembly mount.

6. The suspension assembly of claim 1, wherein movement of the connector apparatus that connects the elongated torsion assemblies results in equal rotation of the first elongate members relative to the second elongate members of all of the elongated torsion assemblies.

7. The suspension assembly of claim 1, wherein the connector apparatus comprises a first offset arm and a second offset arm that are pivotally connected to a force transfer member, wherein a first end of the first offset arm is connected to the first elongate member of first elongated torsion assembly and a first end of the second offset arm is connected to the first elongate member of the second elongated torsion assembly.

8. The suspension assembly of claim 7, wherein the first offset arm connects to the force transfer member at a distance from the first axis equal to the distance that the second offset arm connects to the force transfer member from the second axis, and wherein movement of the connector apparatus that connects the elongated torsion assemblies results in equal rotation of the first elongate members relative to the second elongate members of the first and second elongated torsion assemblies.

9. The suspension assembly of claim 1, wherein the wheel support apparatus is attachable to the connector apparatus by an adjustable pin.

10. The suspension assembly of claim 1, wherein the wheel support apparatus comprises an elongate axle with a wheel hub attached at each end.

11. The suspension assembly of claim 1, wherein the wheel support apparatus comprises a stop device that limits the pivotal movement of the wheel support apparatus relative to the frame.

12. The suspension assembly of claim 1, wherein a force transmitted from the wheel support apparatus is absorbed evenly by all of the elongated torsion assemblies.

13. A carriage having a torsion suspension assembly, the carriage comprising:
a frame;
a first elongated torsion assembly connected within the frame along a first axis, wherein the first elongated torsion assembly comprises a first elongate member and a second elongate member, and further wherein the first elongate member is rotatable relative to the second elongate member about the first axis; and
a second elongated torsion assembly connected within the frame along a second axis, wherein the first axis is parallel to the second axis, wherein the second elongated torsion assembly comprises a first elongate member and a second elongate member, and further wherein the first elongate member is rotatable relative to the second elongate member about the second axis;
a wheel support apparatus that is pivotally attached to the frame; and
a connector apparatus operatively connected to the elongated torsion assemblies and the wheel support apparatus such that movement of the connector apparatus upon movement of the wheel support apparatus results in rotation of the first elongate members relative to the second elongate members of both the first and second elongated torsion assemblies.

14. The carriage of claim 13, wherein each of the first elongate members comprise an inner member connectable in a fixed position within the frame and each of the second elongate members comprise an outer member connectable to the connector apparatus so as to allow rotation of the outer members of the elongated torsion assemblies about the inner members.

15. The carriage of claim 13, wherein the suspension assembly further comprises one or more additional elongated torsion assemblies connectable within the frame along one or more additional axis parallel to the first axis and second axis, wherein the additional torsion assemblies each comprise at least first and second elongate members, and further are operatively connectable such that movement of the connector apparatus upon pivotal movement of the wheel support apparatus results in rotation of each of the first elongate members relative to the second elongate members of all the elongated torsion assemblies.

16. The carriage of claim 13, further comprising a torsion assembly mount connectable to the frame, wherein the first and second elongated torsion assemblies are connected within the frame using the torsion assembly mount, and wherein the wheel support apparatus is pivotally attached to the torsion assembly mount.

17. The carriage of claim 13, wherein movement of the connector apparatus that connects the elongated torsion assemblies results in equal rotation of the first elongate members relative to the second elongate members of all of the elongated torsion assemblies.

18. The carriage of claim 13, wherein the wheel support apparatus further comprises a stop device that limits the pivotal movement of the wheel support apparatus relative to the frame.

19. The carriage of claim 13, wherein a force transmitted from the wheel support apparatus is absorbed evenly by all of the elongated torsion assemblies.

20. A method of absorbing a mechanical shock delivered to a carriage comprising:
providing a first elongated torsion assembly connected within a frame of the carriage along a first axis and a second elongated torsion assembly connected within the frame along a second axis, wherein the first axis is parallel to the second axis; and
providing a wheel support apparatus that is pivotally attached to the frame of the carriage and connected to each of the elongated torsion assemblies such that movement of the wheel support apparatus that results in absorption of at least a portion of the mechanical shock by the first elongated torsion assembly also results in absorption of at least a portion of the mechanical shock by the second elongated torsion assembly.

21. The method of claim 20, wherein absorption of the mechanical shock is distributed evenly between the first elongated torsion assembly and the second elongated torsion assembly.
